(19) United States
(12) Patent Application Publication
(10) Pub. No.: US 2022/0381160 A1
(43) Pub. Date: Dec. 1, 2022

(54) LEVERAGING A TURBOEXPANDER TO PROVIDE ADDITIONAL FUNCTIONALITY IN COMPRESSED GAS FUELED SYSTEMS

(71) Applicant: ZeroAvia, Inc., Hollister, CA (US)

(72) Inventors: Valery MIFTAKHOV, San Carlos, CA (US); Gabriel DeVAULT, Watsonville, CA (US)

(73) Assignee: ZeroAvia, Inc., Hollister, CA (US)

(21) Appl. No.: 17/656,879

(22) Filed: Mar. 28, 2022

Related U.S. Application Data
(60) Provisional application No. 63/168,507, filed on Mar. 31, 2021.

(51) Int. Cl. F01K 25/10; F01D 15/02; F01D 15/10; F01K 7/16

(52) U.S. Cl. CPC F01K 25/10; F01D 15/02; F01D 15/10; F01K 7/16

(57) ABSTRACT

Leveraging a turboexpander to provide additional functionality in compressed gas fueled systems is disclosed. The system includes a compressed gas storage device storing a compressed gas at a first pressure. A turboexpander operably coupled with the compressed gas storage device, the turboexpander comprising a turbine coupled with a drive shaft, the turboexpander to maintain the compressed gas below a threshold temperature limit as it controllably expands the compressed gas from the first pressure to the second pressure via an amount of work obtained from a rotation of the turbine and the drive shaft. A compressed gas receiving device to receive the compressed gas at the second pressure from the turboexpander and generate an amount of electrical energy from the compressed gas.

### CROSS-REFERENCE TO RELATED APPLICATIONS (PROVISIONAL)

This application claims priority to and benefit of co-pending U.S. Provisional Patent Application No. 63/168,507 filed on Mar. 31, 2021, entitled “SYSTEMS AND METHODS LEVERAGING A TURBOEXPANDER TO PROVIDE ADDITIONAL FUNCTIONALITY IN COMPRESSED GAS FUELED SYSTEMS” by Miftakhov et al., and assigned to the assignee of the present application, the disclosure of which is hereby incorporated by reference in its entirety.

### FIELD OF THE INVENTION

Embodiments of the present technology relate generally to systems that utilize compressed gas as fuel, and more particularly, to leveraging a turboexpander to provide additional functionality in a compressed gas fueled system.

### BACKGROUND

In systems that utilize compressed gas as fuel, the compressed gas is often stored (in the system itself and/or separately therefrom) at a storage pressure that is greater than the use pressure of the compressed gas. As a result, the compressed gas is required to be expanded to reduce the pressure from the storage pressure to the use pressure prior to being fed to the fuel cell(s). However, as a gas is expanded, it heats up. To account for the heating of the expanding gas, existing compressed gas fueled systems and fueling stations presently employ active cooling, e.g., chillers, to pre-cool the compressed gas at the storage pressure such that when the compressed gas expands to the use pressure and is thereby heated, the end temperature of the compressed gas at the use pressure is still within acceptable limits. As can be appreciated, employing such a solution requires the consumption of additional energy, e.g., to operate the chillers.

### BRIEF DESCRIPTION OF THE DRAWINGS

Aspects of the present invention are illustrated by way of example, and not by way of limitation, in the accompanying drawings, wherein:

FIG. 1 is a side view of a compressed gas fuel powered aircraft in accordance with an embodiment.

FIG. 2A is a schematic illustration of a compressed gas fuel powered electric engine system of the aircraft of FIG. 1, in accordance with an embodiment.

FIG. 2B is a block diagram of the controller of FIG. 1, in accordance with an embodiment.

FIG. 3 is a schematic illustration of a compressed gas fuel powered vehicle, in accordance with an embodiment.

FIG. 4 is a schematic illustration of a compressed gas fueling station for a compressed gas fuel powered vehicle, in accordance with an embodiment.

FIG. 5 is a schematic illustration of a portion of a compressed gas fuel powered system configured for use with the aircraft of FIG. 1, the vehicle of FIG. 3, the fueling station of FIG. 4, or any other suitable system, wherein the compressed gas fuel powered system includes a turboexpander and leverages the same for additional functionality, in accordance with an embodiment.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

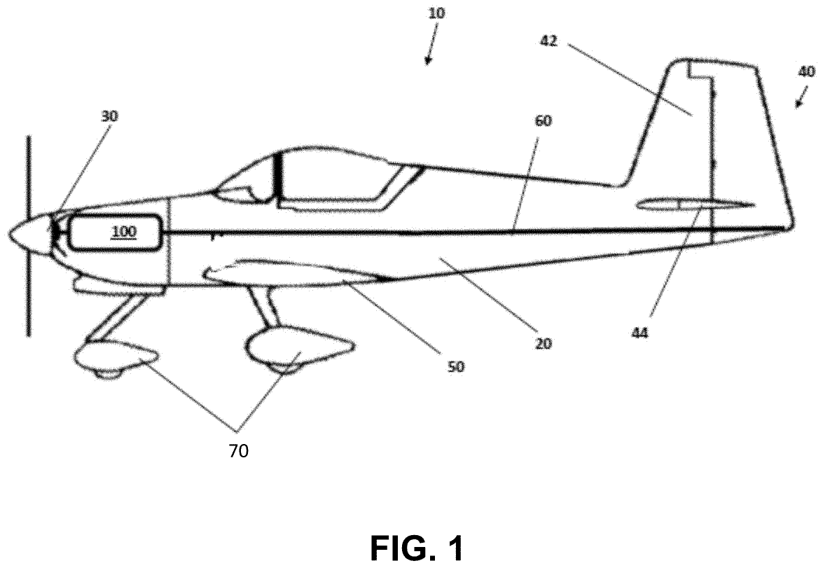

Referring to FIG. 1, a hydrogen fuel powered aircraft 10 is shown in accordance with an embodiment. In one embodiment, hydrogen fuel powered aircraft 10 is a turboprop aircraft. In another embodiment, hydrogen fuel powered aircraft 10 is another aircraft type/configuration other than a turboprop. Although an aircraft 10 is shown, in another embodiment, the device that is utilizing the compressed gas as fuel may be a device such as, for example, a seacraft, an automobile, a power generator, a computing device, a heating, ventilation, and air conditioning (HVAC) system, or the like. However, the turboprop hydrogen fuel powered aircraft 10 disclosed is one embodiment and is provided for purposes of clarity in the following discussion.

Aircraft 10 generally includes a fuselage 20, a propulsor 30 (e.g., a propeller) disposed at a forward end of fuselage 20, a tail 40 disposed at a rear end of fuselage 20 and including a vertical stabilizer 42 and a pair of horizontal stabilizers 44 extending outwardly from either side of tail 40, a pair of wings 50 extending outwardly from either side of fuselage 20, an exhaust system 60, a pair of wheel assemblies 70, and a hydrogen fuel cell powered electric engine system 100.

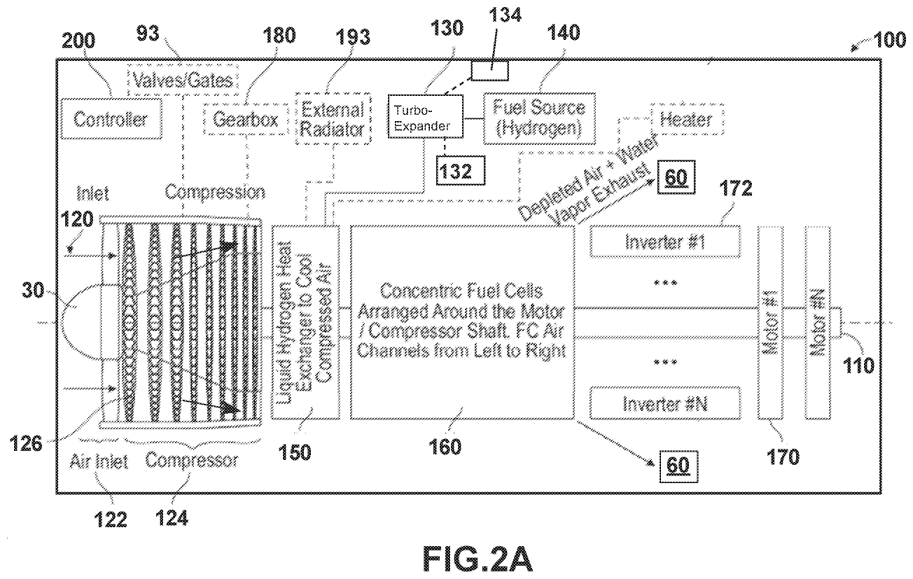

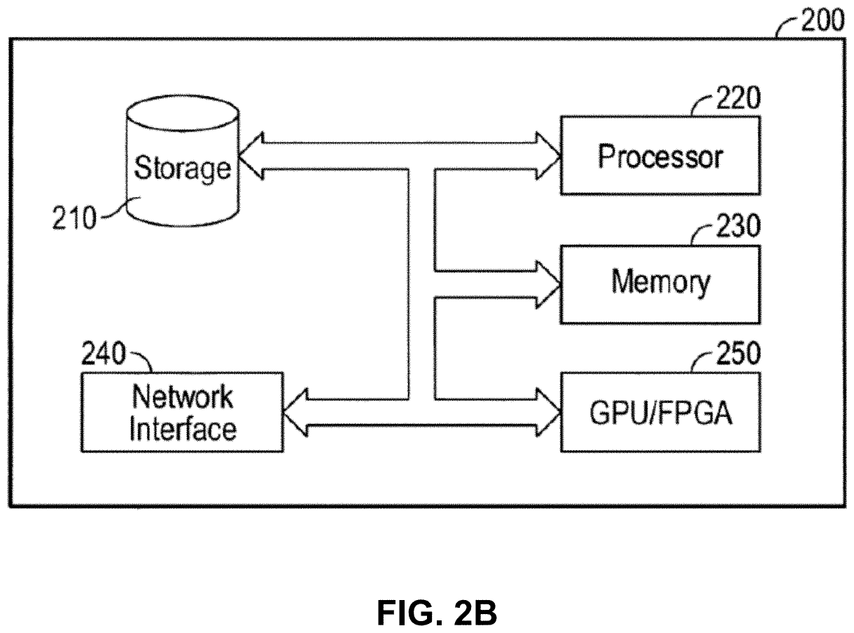

With reference now to FIG. 2A, a block diagram of a hydrogen fuel cell powered electric engine system 100 is shown in accordance with one embodiment. In one embodiment, hydrogen fuel cell powered electric engine system 100 is utilized, for example, in a turboprop or turbofan system, to provide a streamlined, lightweight, power-dense, and efficient system. In one embodiment, hydrogen fuel cell powered electric engine system 100 includes an elongated shaft 10 that defines a longitudinal axis “L” and extends through the entire powertrain of hydrogen fuel cell powered electric engine system 100 to function as a common shaft for the various components of the powertrain. Elongated shaft 110 supports and/or is coupled with propulsor 30, an air compressor system 120, a turboexpander 130 in fluid communication with a fuel source 140, a heat exchanger 150 in fluid communication with air compressor system 120 and turboexpander 130, a hydrogen fuel cell stack 160 in fluid communication with heat exchanger 150, and a motor assembly 170 disposed in electrical communication with fuel cell stack 150.

Air compressor system 120 includes an air inlet portion 122 and a compressor portion 124 positioned rearwardly of air inlet portion 122 to enable uninterrupted, axial delivery of airflow into compressor portion 124 in the forward to rear direction. Compressor portion 124 supports one or more rotatable compressor wheels 126 that rotate in response to rotation of elongated shaft 110 for compressing air received through air inlet portion 122 and pushing the compressed air to fuel cell stack 160 wherein the compressed air is converted to electrical energy.

In one embodiment, the number of compressor wheels/stages 126 and/or diameter, longitudinal spacing, and/or configuration thereof can be modified as desired to change the amount of air supply. In one embodiment, these compressor wheels/stages 126 can be implemented as axial or centrifugal compressor stages. Further, the compressor can have one or more bypass valves and/or wastegates 93 to regulate the pressure and flow of the air that enters the downstream fuel cell stack 160, as well as to manage the cold air supply to any auxiliary heat exchangers in the system.

In one embodiment, compressor system 12 can optionally be mechanically coupled with elongated shaft 110 via a gearbox 180 to enable modification (increase and/or decrease) of the compressor turbine rotations per minute (RPM) and, thus, to change the airflow to fuel cell stack 160. For instance, gearbox 180 may be configured to enable the airflow, or portions thereof, to be exhausted for controlling a rate of airflow through the fuel cell stack 160, and thus, controlling the output power.

In one embodiment, hydrogen fuel cell powered electric engine system 100 also includes a gas management system such as a heat exchanger 150 disposed concentrically about elongated shaft 10 and control thermal and/or humidity characteristics of the compressed air from air compressor system 120 for conditioning the compressed air before entering fuel cell stack 160. That is, heat exchanger 150 is configured to cool the compressed air received from air compressor system 120 with the assistance of the compressed gas, e.g., hydrogen fuel, from fuel source 140 via turboexpander 130. Fuel source 140 may store, for example, hydrogen fuel cryogenically (e.g., as cold hydrogen gas) at a storage pressure. Fuel source 140 is operatively coupled with heat exchanger 150 via turboexpander 130 which serves to enable controlled expansion of the hydrogen gas and, thus, reduction of the pressure thereof to a suitable use pressure. The hydrogen gas, at the use pressure, is fed from turboexpander 130 to heat exchanger 150 for conditioning the compressed air from air compressor system 120.

Turboexpander 130 is described in greater detail below. Briefly, turboexpander 130 is configured, in additional to controlling the expansion and, thus, pressure reduction of the hydrogen gas, to output mechanical energy via an output shaft to a generator 132 for generating electrical energy based thereon and/or to output cool (expanded) hydrogen gas to an air handling system 134, e.g., for use in an HVAC system, for use in cooling electronic components, etc.

Continuing with reference to FIG. 2A, fuel cell stack 160 of hydrogen fuel cell powered electric engine system 100 may be coaxially supported on elongated shaft 110 such that the air channels of fuel cell stack 160 may be oriented in substantially parallel relation with elongated shaft 110. Fuel cell stack 160 may be in the form of a proton-exchange membrane fuel cell (PEMFC) or other suitable fuel cell stack capable of converting chemical energy liberated during the electrochemical reaction of hydrogen and oxygen (received from the heat exchanger 150) to electrical energy (e.g., direct current). Water vapor is exhausted from fuel cell stack 160 to exhaust system 60.

The electrical energy generated from fuel cell stack 160 is transmitted to motor assembly 170, which is also coaxially supported on elongated shaft 110. In one embodiment, hydrogen fuel cell powered electric engine system 100 includes one or more external radiators 193 to facilitate airflow and, in aspects, for additional cooling. Motor assembly 170 includes a plurality of inverters 172 configured to convert the direct current to alternating current for actuating one or more of a plurality of motors 174 of motor assembly 170 in electrical communication with the inverters 172. The plurality of motors 174 are configured to drive (e.g., rotate) elongated shaft 110 in response to the electrical energy received from fuel cell stack 160 for operating the components on the elongated shaft 110 as elongated shaft 110 is rotated, thereby powering aircraft 10 (FIG. 1) and the components thereof.

In one embodiment, the controller 200 may be, for example, a full authority digital engine (or electronics) control (e.g., a FADEC), or other suitable controller for controlling the various aspects of hydrogen fuel cell powered electric engine system 100 and/or other components of aircraft 10 (FIG. 1).

Referring now to FIG. 2B, a controller 200 is shown in accordance with an embodiment. In one embodiment, controller 200 includes a processor 220 connected to a computer-readable storage medium or a memory 230. The computer-readable storage medium or memory 230 may be a volatile type of memory, e.g., RAM, or a non-volatile type memory, e.g., flash media, disk media, etc. In one embodiment, the processor 220 may be another type of processor such as, without limitation, a digital signal processor, a microprocessor, an ASIC, a central processing unit (CPU), or the like. In one embodiment, controller 200 includes a graphics processing unit (GPU)/field-programmable gate array (FPGA) 250. In one embodiment, processor 220 is a GPU/FPGA such as GPU/FPGA 250. In one embodiment, network inference may also be accomplished in systems that have weights implemented as memristors, chemically, or other inference calculations, as opposed to processors.

In one embodiment, the memory 230 can be random access memory, read-only memory, magnetic disk memory, solid-state memory, optical disc memory, and/or another type of memory. In one embodiment, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In one embodiment, the controller 200 may include a network interface 240 to communicate with other computers or to a server. A storage device 210 may be used for storing data.

The disclosed method may run on the controller 200 or on a user device, including, for example, a mobile device, an IoT device, a server system, or the like.

In one embodiment, controller 200 is configured to receive, among other data, the fuel supply status, aircraft location, and control, among other features, the pumps, motors, sensors, etc.

Referring now to FIGS. 2A and 2B, in one embodiment, the hydrogen fuel cell powered electric engine system 100 can include any number and/or type of sensors, electrical components, and/or telemetry devices that are operatively coupled with controller 200 for facilitating the control, operation, and/or input/out of the various components of hydrogen fuel cell powered electric engine system 100 for improving efficiencies and/or determining errors and/or failures of the various components.

For a more detailed description of components of similar hydrogen fuel cell powered electric engine systems, one or more components of which can used or modified for use with the structure of the present disclosure, reference can be made, for example, to U.S. patent application Ser. No. 16/950,735.

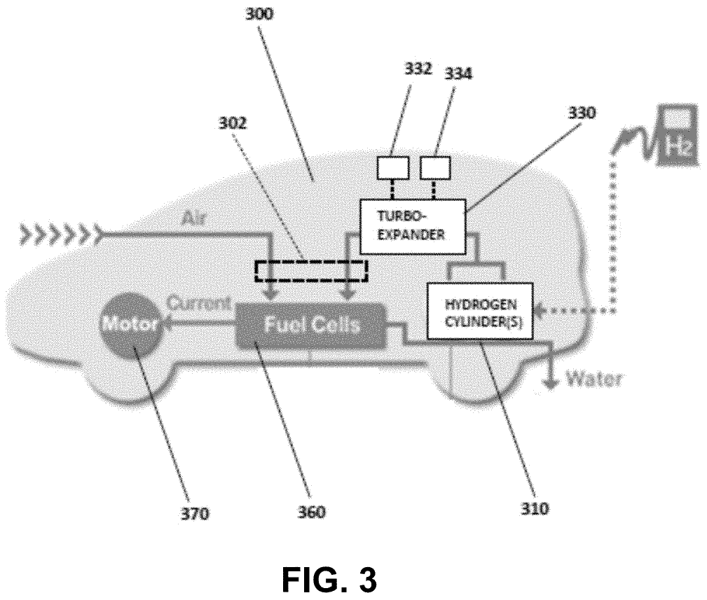

Referring now to FIG. 3, a schematic diagram of a compressed gas, e.g., hydrogen fuel cell powered vehicle 300 is shown in accordance with one embodiment. In one embodiment, hydrogen fuel cell powered vehicle 300 includes one or more hydrogen gas storage tanks 310, a turboexpander 330, a hydrogen fuel cell stack 360, and an electric motor 370. Although in one embodiment, hydrogen fuel cell powered vehicle 300 is an automobile, in another embodiment, hydrogen fuel cell powered vehicle 300 may be another vehicle such as a motorcycle, motorized bicycle, side-by-side, snow machine, personal water craft (PWC), boat, helicopter, airplane, truck, bus, recreational vehicle, or the like.

In one embodiment, hydrogen fuel cell powered vehicle 300 may additionally include other system components 302 similar to those detailed above with respect to system 100 of aircraft 10 (FIGS. 1 and 2A-2B), e.g., an air compressor system and heat exchanger, to facilitate conditioning compressed air and hydrogen gas prior to directing the same to fuel cell stack 360. Indeed, the general operating principles of hydrogen fuel cell powered aircraft 10 (FIG. 1) detailed above may apply similarly to the operation of hydrogen fuel cell powered vehicle 300.

Turboexpander 330 is described in greater detail below. In general, turboexpander 330 is configured to reduce the pressure of hydrogen gas from storage tanks 310 to a suitable pressure for input to fuel cell stack 360 and, as a function of the expansion of the hydrogen gas therein, is also configured to output mechanical energy via an output shaft to a generator 332 for generating electrical energy based thereon and/or to output cool (expanded) hydrogen gas to an air handling system 334, e.g., for use in an HVAC system (such as for use in cooling electronic components, etc.).

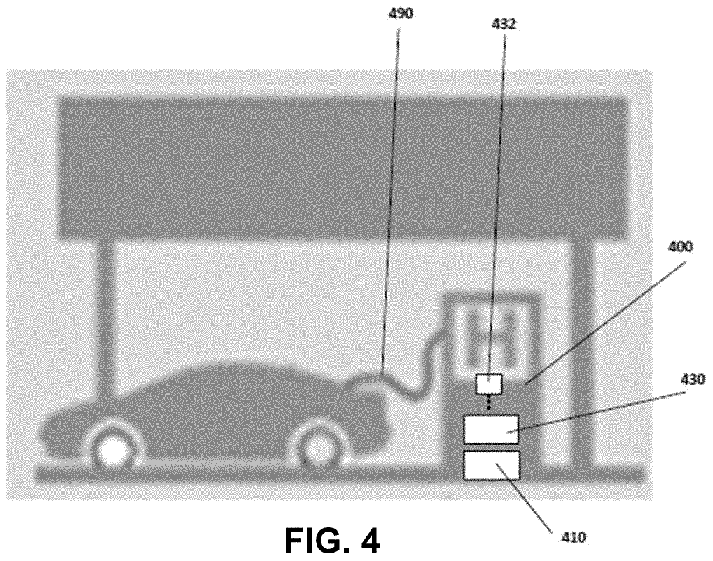

With reference to FIG. 4, a compressed gas, e.g., hydrogen fueling station 400 is shown in accordance with one embodiment. In one embodiment, hydrogen fueling station including one or more hydrogen gas storage tanks 410, a turboexpander 430, and a delivery hose and nozzle assembly 490. In one embodiment, hydrogen fueling station 400 is a stationary fueling station for refueling a hydrogen fuel powered vehicle. In another embodiment, hydrogen fueling station 400 may be stationary or portable. In one embodiment, turboexpander 430 enables the expansion and depressurization of the hydrogen gas stored in the hydrogen gas storage tank(s) 410 (e.g., at the storage pressure) for output via delivery hose and nozzle assembly 490 to the vehicle at a lower pressure (e.g., a use or vehicle storage pressure). In one embodiment, turboexpander 430 enables the output of mechanical energy via an output shaft to a generator 432 for generating electrical energy based thereon.

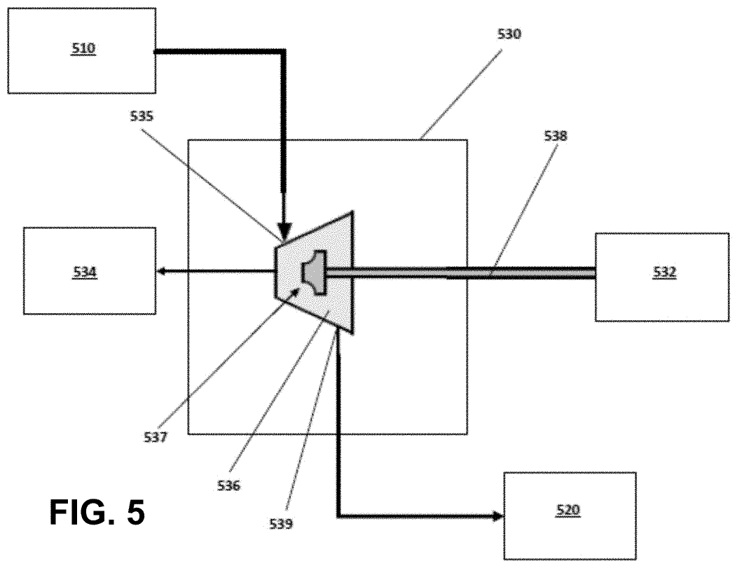

Referring to FIG. 5, a turboexpander 530 which may act as turboexpander 130 (FIG. 2A), turboexpander 330 (FIG. 3), and/or turboexpander 430 (FIG. 4) is shown in accordance with one embodiment. In one embodiment, turboexpander 530 is operably coupled with a compressed gas storage device 510, e.g., a hydrogen gas storage tank, storing gas a storage pressure, and a compressed gas use device 520, e.g., a hydrogen fuel cell stack (or other storage or use device), configured to use (or store) gas at a use (or second storage) pressure lower than the storage pressure. Although described with respect to hydrogen gas, in another embodiment, turboexpander 530 may be utilized with any other suitable compressed gas, e.g., compressed oxygen, compressed air, etc. Turboexpander 530 is illustrated as coupled with devices 510, 520 for simplicity of understanding; however, it is contemplated that any suitable intermediate components be coupled with and/or between device 510 and turboexpander 530 and/or turboexpander 530 and device 520.

In one embodiment, turboexpander 530 includes an inlet 535 to receive the hydrogen gas at the relatively higher storage pressure and defines an internal cavity 536 including a turbine 537 mounted on a drive shaft 538. In one embodiment, during the operation of turboexpander 530 as the hydrogen gas enters internal cavity 536 via inlet 535, the hydrogen gas expands, this expansion doing work in the form of driving rotation of turbine 537 and, thus, drive shaft 538. Turboexpander 530 functions such that, rather than the hydrogen gas being heated at it expands within internal cavity 536, the energy that would otherwise be generated as thermal energy is instead generated as mechanical energy in the form of work done by the expanding gas to drive rotation of turbine 537. In other words, at turboexpander 530 the energy in the input, higher-pressure (and, thus, higher-energy) hydrogen gas is transformed into mechanical energy in the form of rotation of drive shaft 538 as the hydrogen gas expands such that the hydrogen gas is not heated (or is minimally heated or, in fact, is cooled from its initial temperature). The expanded, low temperature hydrogen gas exits outlet 539 to the gas use device 520 in a useable condition, e.g., suitable temperature and pressure, for use thereby.

Continuing with reference to FIG. 5, in one embodiment, the work done by the expanding gas in turboexpander 530 drives rotation of turbine 537 and, thus, drive shaft 538. In one embodiment, drive shaft 538 is coupled with a generator 532 which generates electrical energy based on the mechanical rotational input imparted thereto via drive shaft 538. This electrical energy generated by generator 532 may be utilized to power other components and/or systems. As can be appreciated, such a configuration is advantageous in that turboexpander 530 not only performs its primary purposes of enabling controlled pressure release (expansion) of the hydrogen gas from the storage pressure to the use pressure, but also provides secondary functionality in that the energy released by the expanding gas in turboexpander 530 is utilized to generate usable electrical energy for other components and/or systems, rather than being lost (or requiring input energy to control depressurization of the hydrogen gas). In addition, by transforming this energy into mechanical (work) energy, rather than thermal energy, the expanding gas is not heated and, thus, does not need to be cooled (or pre-cooled prior to expansion) to achieve a suitable temperature for use by device 520.

In addition to or as an alternative to electrical energy generation by generator 532, some of the cooled, expanded hydrogen gas within turboexpander 530 may be routed to an air handling system 534 such as, for example an HVAC system, or other environmental conditioning system. In this manner, yet another secondary function of turboexpander 530 is realized.

It should be understood the disclosed structure can include any suitable mechanical, electrical, and/or chemical components for operating the disclosed system or components thereof. For instance, such electrical components can include, for example, any suitable electrical and/or electromechanical and/or electrochemical circuitry, which may include or be coupled with one or more printed circuit boards. As appreciated, the disclosed computing devices and/or server can include, for example, a “controller,” “processor,” “digital processing device” and like terms, and which are used to indicate a microprocessor or central processing unit (CPU).

In one embodiment, the CPU is the electronic circuitry within a computer that carries out the instructions of a computer program by performing the basic arithmetic, logical, control and input/output (I/O) operations specified by the instructions, and by way of non-limiting examples, include server computers. In one embodiment, the controller includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In one embodiment, the operating system is provided by cloud computing.

In one embodiment, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In one embodiment, the controller includes a storage and/or memory device. The storage and/or memory device is one or more physical apparatus used to store data or programs on a temporary or permanent basis. In one embodiment, the controller includes volatile memory and requires power to maintain stored information. In one embodiment, the controller includes non-volatile memory and retains stored information when it is not powered. In one embodiment, the non-volatile memory includes flash memory. In one embodiment, the non-volatile memory includes dynamic random-access memory (DRAM). In one embodiment, the non-volatile memory includes ferroelectric random-access memory (FRAM). In one embodiment, the non-volatile memory includes phase-change random access memory (PRAM). In one embodiment, the controller is a storage device including, by way of non-limiting examples, CD-ROMs, DVDs, flash memory devices, magnetic disk drives, magnetic tapes drives, optical disk drives, and cloud-computing-based storage. In one embodiment, the storage and/or memory device is a combination of devices such as those disclosed herein.

In one embodiment, the memory can be random access memory, read-only memory, magnetic disk memory, solid state memory, optical disc memory, and/or another type of memory. In one embodiment, the memory can be separate from the controller and can communicate with the processor through communication buses of a circuit board and/or through communication cables such as serial ATA cables or other types of cables. The memory includes computer-readable instructions that are executable by the processor to operate the controller. In one embodiment, the controller may include a wireless network interface to communicate with other computers or a server. In one embodiment, a storage device may be used for storing data. In one embodiment, the processor may be, for example, without limitation, a digital signal processor, a microprocessor, an ASIC, a graphics processing unit (“GPU”), field-programmable gate array (“FPGA”), or a central processing unit (“CPU”).

The memory stores suitable instructions, to be executed by the processor, for receiving the sensed data (e.g., sensed data from GPS, camera, etc. sensors), accessing storage device of the controller, generating a raw image based on the sensed data, comparing the raw image to a calibration data set, identifying an object based on the raw image compared to the calibration data set, transmitting object data to a ground-based post-processing unit, and displaying the object data to a graphic user interface. Although illustrated as part of the disclosed structure, in one embodiment, a controller may be remote from the disclosed structure (e.g., on a remote server), and accessible by the disclosed structure via a wired or wireless connection. In one embodiment where the controller is remote, it may be accessible by, and connected to, multiple structures and/or components of the disclosed system.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IoT device, or a server system.

In one embodiment, the controller includes a display to send visual information to a user. In one embodiment, the display is a cathode ray tube (CRT). In one embodiment, the display is a liquid crystal display (LCD). In one embodiment, the display is a thin film transistor liquid crystal display (TFT-LCD). In one embodiment, the display is an organic light-emitting diode (OLED) display. In one embodiment, on OLED display is a passive-matrix OLED (PMOLED) or active-matrix OLED (AMOLED) display. In one embodiment, the display is a plasma display. In one embodiment, the display is a video projector. In one embodiment, the display is interactive (e.g., having a touch screen or a sensor such as a camera, a 3D sensor, a LiDAR, a radar, etc.) that can detect user interactions/gestures/responses and the like. In one embodiment, the display is a combination of devices such as those disclosed herein.

The controller may include or be coupled with a server and/or a network. As used herein, the term “server” includes “computer server,” “central server,” “main server,” and like terms to indicate a computer or device on a network that manages the disclosed apparatus, components thereof, and/or resources thereof. As used herein, the term “network” can include any network technology including, for instance, a cellular data network, a wired network, a fiber-optic network, a satellite network, and/or an IEEE 802.11a/b/g/n/ac wireless network, among others.

In one embodiment, the controller can be coupled with a mesh network. As used herein, a “mesh network” is a network topology in which each node relays data for the network. In general, mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In one embodiment, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines or sections of programs that perform a particular task.

In one embodiment, the controller includes software modules for managing various functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

In one embodiment, the described methods, programs, systems, codes, and the like may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed is:

1. A system comprising:
a compressed gas storage device storing a compressed gas at a first pressure;
a compressed gas receiving device configured to receive said compressed gas at a second pressure less than said first pressure and to generate electrical energy based at least partially thereon; and
a turboexpander operably coupled with said compressed gas storage device and said compressed gas receiving device, said turboexpander configured to enable controlled expansion of said compressed gas from said first pressure to said second pressure, said turboexpander comprising:
a drive shaft; and
a turbine coupled with said drive shaft, wherein expansion of said compressed gas within said turboexpander performs work in a form of driving a rotation of said turbine and said drive shaft, thereby maintaining said compressed gas below a threshold temperature limit when expanded to said second pressure.

2. The system of claim 1, further comprising:
a generator separate from said compressed gas receiving device, said generator coupled with said drive shaft, said generator configured to generate electrical energy in response to said rotation of said drive shaft.

3. The system of claim 1, wherein said turboexpander is configured to divert a portion of said compressed gas, at said second pressure, to a device from a group consisting of: an air handling system and a cooling system.

4. The system of claim 1, wherein said compressed gas is hydrogen.

5. The system of claim 1, further comprising:
a compressed gas powered vehicle;
said compressed gas storage device is a compressed gas storage tank of said compressed gas powered vehicle; and
said compressed gas receiving device is a power generating component of said compressed gas powered vehicle.

6. The system of claim 5, wherein said compressed gas powered vehicle is selected from a group consisting of an aircraft, a motorcycle, a motorized bicycle, a side-by-side, a snow machine, a personal water craft (PWC), a boat, a helicopter, a truck, a bus, and a recreational vehicle.

7. The system of claim 5, wherein said compressed gas receiving device comprises:
at least one compressed gas fuel cell.

8. The system of claim 7, wherein said compressed gas powered vehicle comprises:
a heat exchanger disposed between said compressed gas storage device and said at least one compressed gas fuel cell.

9. The system of claim 8, wherein said compressed gas powered vehicle further comprises:
a generator coupled with said drive shaft, said generator configured to generate electrical energy in response to rotation of said drive shaft, said generator separate from said compressed gas receiving device.

10. The system of claim 5, further comprising:
an environmental conditioning system for said compressed gas powered vehicle, said environmental conditioning system to receive a portion of said compressed gas, at said second pressure diverted from said turboexpander, said environmental conditioning system from a group consisting of: an air handling system and a cooling system.

11. The system of claim 1, further comprising:
a compressed gas fueling system comprising:
said compressed gas storage device; and
said turboexpander,
said compressed gas fueling system configured to releasably couple with said compressed gas receiving device for providing said compressed gas, at said second pressure, thereto.

12. The system of claim 11, further comprising:
a compressed gas powered vehicle, said compressed gas powered vehicle configured to couple with said compressed gas fueling system, said compressed gas powered vehicle comprising said compressed gas receiving device.

13. A method for leveraging a turboexpander to provide additional functionality in a compressed gas fueled system, said method comprising:
accessing a compressed gas storage device storing a compressed gas at a first pressure;
operably coupling said turboexpander with said compressed gas storage device, said turboexpander comprising:
a drive shaft; and
a turbine coupled with said drive shaft;
utilizing said turboexpander to controllably expand said compressed gas from said first pressure to a second pressure, said second pressure less than said first pressure;
generating work via a driving of a rotation of said turbine and said drive shaft as said turboexpander controllably expands said compressed gas from said first pressure to said second pressure, said work maintaining said compressed gas below a threshold temperature limit as it is controllably expanded to said second pressure;
providing said compressed gas at said second pressure from said turboexpander to a compressed gas receiving device; and
using said compressed gas at said compressed gas receiving device to generate electrical energy.

14. The method of claim 13, further comprising:
utilizing a generator coupled with said drive shaft to generate electrical energy in response to said rotation of said drive shaft.

15. The method of claim 13, further comprising:
diverting a portion of said compressed gas, at said second pressure, from said turboexpander to a device from a group consisting of: an air handling system and a cooling system.

16. The method of claim 13, wherein said electrical energy is used to power a vehicle is selected from a group consisting of an aircraft, a motorcycle, a motorized bicycle, a side-by-side, a snow machine, a personal water craft (PWC), a boat, a helicopter, a truck, a bus, and a recreational vehicle.

17. A compressed gas fuel system comprising:
a compressed gas storage device storing a compressed gas at a first pressure;
a turboexpander operably coupled with said compressed gas storage device, said turboexpander comprising a turbine coupled with a drive shaft, said turboexpander to maintain said compressed gas below a threshold temperature limit as it controllably expands said compressed gas from said first pressure to a second pressure, less than said first pressure, via an amount of work obtained from a rotation of said turbine and said drive shaft; and
a compressed gas receiving device configured to:
receive said compressed gas at said second pressure from said turboexpander; and
generate an amount of electrical energy from said compressed gas.

18. The compressed gas fuel system of claim 17, further comprising:
a generator separate from said compressed gas receiving device, said generator coupled with said drive shaft, said generator configured to generate electrical energy in response to said rotation of said drive shaft.

19. The compressed gas fuel system of claim 17, wherein said turboexpander is configured to divert a portion of said compressed gas, at said second pressure, to a device from a group consisting of: an air handling system and a cooling system.

20. The compressed gas fuel system of claim 17, further comprising:
a compressed gas powered vehicle, said compressed gas powered vehicle is selected from a group consisting of an aircraft, a motorcycle, a motorized bicycle, a side-by-side, a snow machine, a personal water craft (PWC), a boat, a helicopter, a truck, a bus, and a recreational vehicle;
said compressed gas storage device is a compressed gas storage tank of said compressed gas powered vehicle; and
said compressed gas receiving device is a power generating component of said compressed gas powered vehicle.
